(19) United States
(12) Patent Application Publication
(10) Pub. No.: US 2011/0052427 A1
(43) Pub. Date: Mar. 3, 2011

(54) HIGH PRESSURE TWO-PIECE PLUNGER PUMP ASSEMBLY

(75) Inventors: Anthony A. SHAULL, Columbus, IN (US); David L. BUCHANAN, Westport, IN (US); Lester L. PETERS, Columbus, IN (US)

(73) Assignee: CUMMINS INTELLECTUAL PROPERTIES, INC., Minneapolis, MN (US)

(21) Appl. No.: 12/552,752

(22) Filed: Sep. 2, 2009

(51) Int. Cl. F04B 17/05; F02M 37/06

(52) U.S. Cl. 417/364; 123/508

(57) ABSTRACT

A high pressure pumping apparatus for of an internal combustion engine includes a pump barrel having a bore with a central axis, and a two-part pumping plunger provided in the bore of the barrel. The two-part plunger includes first and second pumping plunger parts that are separate from one another and arranged substantially coaxial with the central axis of the barrel's bore. A first distal end portion of the first pumping plunger part abuts a first distal end portion of the second pumping plunger part, and a second distal end portion of the first pumping plunger part in part defines a pumping chamber. The high pressure pumping apparatus includes and a tappet assembly that is operably coupled to the second distal end portion of the second pumping plunger part for operably engaging a rotating camshaft, which causes the first and second plunger parts to move in reciprocal motion.

### FIELD OF THE INVENTION

An apparatus for pumping fluid is disclosed.

### BACKGROUND

Internal combustion engines having common-rail fuel delivery systems utilize high pressure fuel pumps to ensure adequate fuel pressure inside the rail at low engine speeds and to provide good air and fuel mixture at high engine speeds. To meter and pressurize fuel, a high pressure fuel pump typically has a single-piece pumping plunger reciprocating within a bore of a barrel in the pump's body.

### SUMMARY

An improved high pressure fuel pumping apparatus for an internal combustion engine exhibiting increased efficiency and reliability is provided by the invention.

More particularly, embodiments consistent with the invention relate to a high pressure pumping apparatus including a pump barrel having a bore with a central axis. A pumping plunger is provided in the bore of the barrel and includes a first pumping plunger part and a second plunger part. The first and second pumping plunger parts are separate from one another and arranged substantially coaxial with the central axis of the bore. A first distal end portion of the first pumping plunger part abuts a first distal end portion of the second pumping plunger part, and a pumping chamber is defined in part by a second distal end portion of the first pumping plunger part. The high pressure pumping apparatus includes and a tappet assembly that is operably coupled to a second distal end portion of the second pumping plunger part for operably engaging a rotating camshaft, which causes the first and second pumping plunger parts to move in reciprocal motion.

In accordance with another aspect consistent with the invention, an embodiments of a high pressure fuel pump comprises a pump barrel including a cylindrically shaped bore, a pumping chamber at one end of the bore, and a first cylindrically shaped plunger part positioned in the bore and including a side surface defining a movable surface of the pumping chamber. A second cylindrically shaped plunger part is positioned in the bore and has a diameter smaller than a diameter of the first plunger part, and is adapted to be reciprocally driven at a first end and to drive the first plunger part in the bore at a second end.

It is to be understood that both the foregoing general description and the following detailed description are exemplary and exemplary only and are not restrictive of the invention, as claimed.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1 is a cross-sectional view of a portion of a high pressure fuel assembly in accordance with an exemplary embodiment.

FIG. 2 is an enlarged cross-sectional view of the pump barrel assembly of FIG. 1 in accordance with an exemplary embodiment.

FIG. 3 is a graph depicting fuel delivery performance at constant fuel temperature of 40 C for exemplary two-piece plunger pump assembly apparatus embodiments and a standard single-piece plunger pump configuration operating over different engine speeds and pumping pressures.

FIG. 4 is a graph depicting fuel delivery performance at constant fuel temperature of 70 C for exemplary two-piece plunger pump assembly apparatus embodiments and a standard single-piece plunger pump configuration operating over different engine speeds and pumping pressures.

FIG. 5 is a graph depicting fuel delivery performance operating at constant 2600 bar over different engine speeds for exemplary two-piece plunger pump assembly apparatus embodiments and a standard pump configuration, where the fuel temperature of the standard single-piece plunger pump configuration and one of the two-piece plunger pump assembly apparatuses is 40 C, and the remaining two-piece plunger pump assembly apparatus is cooled.

FIG. 6 is a bar graph depicting fuel delivery performance and volumetric efficiency of exemplary two-piece plunger pump assembly apparatus embodiments and a standard pump configuration operated at 1000 RPM, where the fuel temperature of the standard configuration pump and one of the two-piece plunger pump assembly apparatuses is 40 C, and the remaining two-piece plunger pump assembly apparatus is cooled.

### DETAILED DESCRIPTION

The various aspects are described hereafter in greater detail in connection with a number of exemplary embodiments to facilitate an understanding of the invention. However, the invention should not be construed as being limited to these embodiments. Rather, these embodiments are provided so that the disclosure will be thorough and complete, and will fully convey the scope of the invention to those skilled in the art.

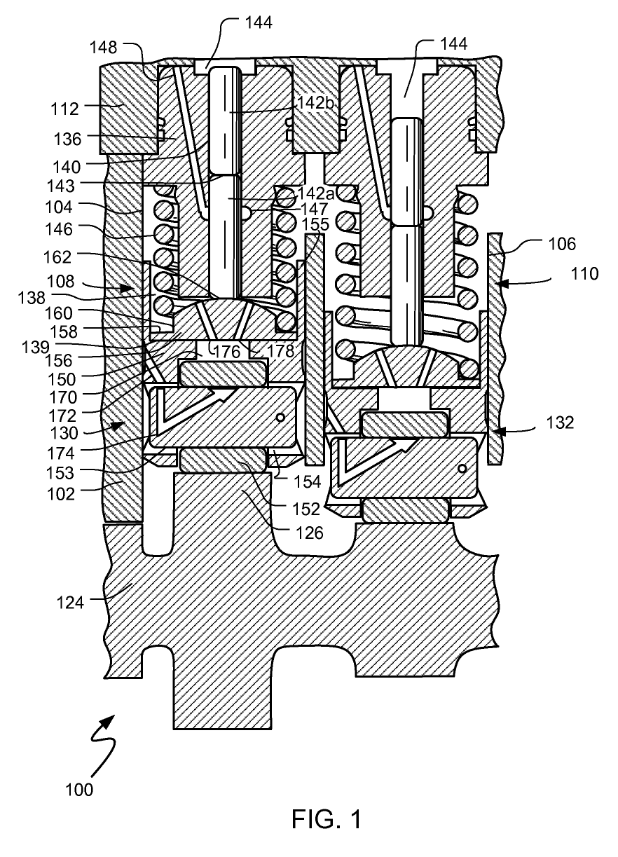

FIG. 1 shows a cross-section view of a portion of a high pressure fuel pump assembly 100 according to an exemplary embodiment. The high pressure fuel pump assembly 100 includes a pump housing 102 provided with bores 104 and 106, and pump units 108 and 110 provided in the bores 104 and 106. The fuel pump assembly 100 has a pump head 112 mounted on pump housing 102 to cover and seal the bores 104 and 106. A rotatably mounted camshaft 124 extends through pump housing 102 and functions to operate pump units 108 and 110 via tappet assemblies 130 and 132. It will be recognized that because FIG. 1 depicts a partial cross-section, only portions of some parts, such as the pump housing 102, pump head 112 and camshaft 124, are shown. Because the pump units 108 and 110 of fuel pump assembly 100 are structurally the same, only pump unit 108 will be described hereinafter. The camshaft 124 can be part of a drive system including the rotating cam and tappet assemblies 130 and 132, located in a separate mechanical compartment containing lubricating oil, such as disclosed in U.S. Pat. Nos. 5,775,203 and 5,983,863, each of which is hereby incorporated by reference in their entirety.

The pump unit 108 includes a pump barrel 136 having a barrel bore 140 in which a two-piece, or “dual” plunger assembly including a lower pumping plunger part 142a and an upper pumping plunger part 142b are provided substantially coaxial with the barrel bore 140. The lower pumping plunger part 142a and the upper pumping plunger part 142b are provided as separate pieces in the barrel bore 140. “Separate”, as used herein with respect to the upper and lower pumping plunger parts 142a/142b, means the upper pumping plunger part 142b is not integral with or physically connected to the lower pumping plunger part 142a. Thus, the upper pumping plunger part 142b “floats” in the barrel bore 140 and its movement is a result of forces from pressure differential and/or the lower pumping plunger 142a acting on it. During operation of the pump assembly 100, an upper surface of the plunger part 142a can contact a lower surface of the plunger part 142b at an interface 143 as they reciprocate in the barrel bore 140. Further, it is to be understood that the terms “upper” and “lower,” as used herein, refer to the orientation exemplary pump assemblies shown in the figures. In other exemplary embodiments consistent with the invention, the orientation of two-piece plunger parts may be flipped relative to the depicted orientations, or both plunger parts may reside on a same vertical plane, for example.

Returning to FIG. 1, the pumping plunger parts 142a/142b have respective distal end portions positioned adjacent one another and move together in a reciprocal manner as they are driven by the tappet assembly 130. The tappet assembly 130 is biased toward the camshaft 126 by a spring 146 positioned in the bore 104 of the housing 102. The pump barrel 136 can include one or more mechanism, such as groove 147 that communicates with a drain passage 148 that permits low pressure escape for fuel leakage from the plunger parts 142a/142b. At the top of the pump barrel 136, a pumping chamber 144 is defined in part by a portion of the barrel bore 140 and a distal end portion of the upper pumping plunger part 142b. Because the pumping plunger part 142b reciprocates within the bore 140, the pumping chamber 144 varies in size when the upper pumping plunger part 142b operates in a pumping stroke to decrease the size of pumping chamber 144 while pressurizing fuel and in a retraction stroke to increase the size of the chamber 144 while drawing fuel into the chamber 144.

The tappet assembly 130 includes a tappet housing 150 adapted for reciprocal motion along tappet guiding surfaces provided in the pump housing by the bore 104. The tappet assembly 130 includes a cam roller 152 rotatably secured to housing 150 by a pin 153 extending through a bore 154 in tappet housing 150. Tappet housing 150 also includes an annular skirt 155 extending toward pump head 112 to form a recess 138 having an inner support surface 139.

The high pressure fuel pump unit 108 further includes a force transmitting device 156 provided on the support surface 139 between tappet assembly 130 and lower plunger part 142a for transmitting axial loads to lower plunger part 142a. Force transmitting device 156 includes a spring seating surface 158 for receiving the outer end of the spring 146 and a lateral retaining surface 160 that prevents lateral movement of the spring 146. The force transmitting device 156 includes a supporting end 162, which abuts, attaches, or otherwise couples to a distal end portion of the lower plunger part 142a. The lower plunger part 142a can float in the barrel bore 140 such that it is not physically connected to the force transmitting device 156, its movement in the bore resulting from forces acting on it from the force transmitting device 156 and/or the upper pumping plunger 142b.

The high pressure fuel pump assembly 100 can include a lubricating oil circuit that includes various lubricating transfer passages 170, 172, and 174 provided in the components of tappet assembly 130. In addition, lubricating oil circuit can include passages 176, 178 in the force transmitting device 156.

During operation, the spring 146 is positioned in abutment against the force transmitting device 156 at one end and the barrel 136 at its other end. The spring 146 biases tappet assembly 130 via the force transmitting device 156 into engagement with the camshaft 124 at an opposite end. As the camshaft 124 rotates, a lobe 126 of the camshaft 124 displaces the tappet assembly 130 within the bore 104, and thus also displaces the transmitting device 156, the lower plunger part 142a, and the upper plunger part 142b.

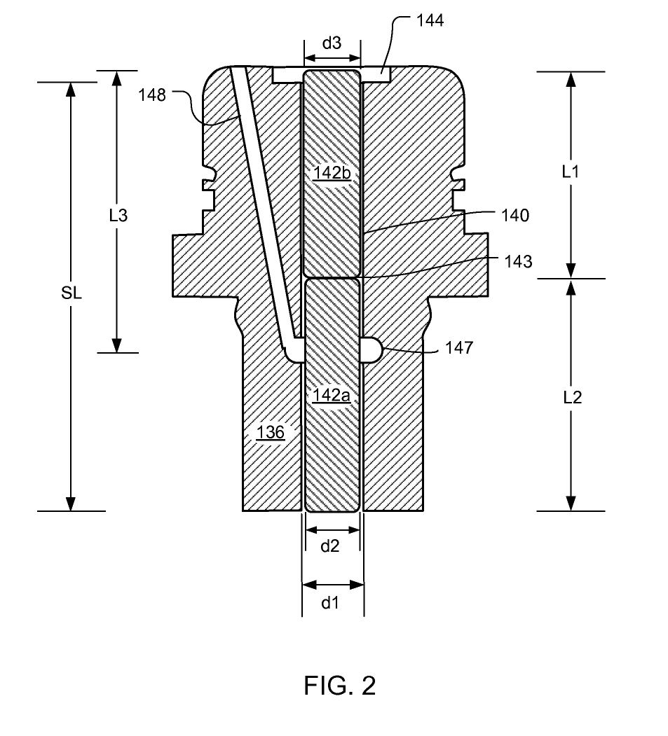

To substantially improve pumping efficiency, embodiments include separate pumping plunger to barrel bore clearance requirements for the coaxial pumping plunger parts. Referring to FIG. 2, the barrel bore 140 can be cylindrical with a diameter d1 and house cylindrical lower pumping plunger part 142a and a cylindrical upper pumping plunger part 142b. The lower pumping plunger part 142a can be shaped with a constant diameter d2 to provide clearance, i.e., d1-d2, between its outer surface and the surface of the bore 140 that is sufficient to minimize the likelihood of sticking and seizure of the lower pumping plunger part 142a in the barrel bore 140. The upper pumping plunger 142b can be shaped with a constant diameter d3 to provide clearance d1-d3 between its outer surface and the barrel bore 140, which is smaller than the bore-to-plunger clearance of lower pumping plunger 142a to minimize fuel leakage. For example, an embodiment can have a clearance d1-d2 for the lower pumping plunger part 142a in a range of about 4 to 6 μm, where the particular value in the range can be selected based on a required common rail pump pressure and robustness to sticking and seizure. The upper pumping plunger part 142b can have tighter clearance with the barrel bore 140, d1-d3, because fuel pumping pressure acts on the upper end face of the upper plunger part 142b and the barrel bore 140 at the pumping chamber 144, and dilates an upper area of the barrel bore 140 where the upper pumping plunger part 142b reciprocates. A tighter bore-to-plunger clearance for the upper pumping plunger part 142b, in turn, reduces the amount of fuel leakage from the pumping chamber 144 to provide improved high pressure efficiency and reliability.

The two-piece plunger assembly comprising two pumping plungers 142a/142b can be designed to optimally address issues specific to each portion of the seal length of the barrel bore. As shown in FIG. 2, the diameter d3 of the upper pumping plunger part 142b is constant along its entire length L1. This provides a substantially constant close fit along the length L1 from one end to the other of the pumping plunger part 142b. In addition, the length L1 of the pumping plunger part 142b can be set to extend at least as long as dilation of an upper portion of the barrel bore 140 during a pressurizing stroke of the pump assembly 100, such as along a substantial portion of the seal length SL of the barrel bore 140. For example, the upper pumping plunger length L1 shown in FIG. 2 extends along the majority of the seal length SL above low pressure escape groove 147. Additionally, the lower pumping plunger length L2 can extend along the bore seal length SL continuously from the lower end of the upper pumping plunger part 142b to the lower end of the barrel bore 140.

In an exemplary embodiment, a plunger-to-bore clearance d1-d3 of the top pumping plunger part 142b can be one half to one quarter of the clearance d1-d2 of the lower pumping plunger part 142a. Thus, for an exemplary embodiment in which a lower pumping plunger part 142a has a clearance of within a range of about 4 to 6 μm, the upper pumping plunger part 142b can have a clearance between about 2.0 to 3.0 μm, or between about 1.0 to 1.5 μm for more efficient operation. The limit to which a clearance can be set for the upper plunger can be based on, for example, machining limitations, material limitations, cost, and/or pressure required for a particular fuel system application.

The two piece plunger can allow for a tighter clearance on the upper pumping plunger part 142b only, which provides an efficiency lever because of reduced high pressure leakage during pumping. The pressure developed on the upstroke of the two-piece plunger will open (i.e., dilate) an upper portion of the barrel bore 140 during pressurization unlike a lower portion of the barrel bore 140, so a tighter the clearance of the upper plunger part 142b and the barrel bore 140 provides better pumping efficiency. Because dilation is related to the pressure in the bore, above the pumping plunger part 142b would have full dilation because it would have full pressure. The pressure is assumed to drop along the match fit to zero in the drain/leakage low pressure groove 147, and the majority of dilation has been observed in about the first ⅓^{rd} of the match fit clearance. Efficiency improvement can be realized with any upper pumping plunger part match being less than the lower pumping plunger part (or single plunger) clearance. Tight clearances, such as clearances less than 1.0 μm, can be applied with improvements in bore and plunger manufacturing. Hence, the clearance of the pumping plunger part 142b could be anything less than the clearance lower pumping plunger part 142a, and can approach zero clearance with increasing efficiency to an extent allowed by manufacturing capability.

The length L1 of the upper pumping plunger part 142b can be related to an upper bore length L3, which is shown in FIG. 2 as a distance measured from the low pressure drain/leakage groove 147 to the top of the upper pumping plunger part 142b when the plunger part 142b is at top dead center (TDC) in barrel bore 140, and to the stroke of the reciprocating motion of the tappet assembly 130. This relation involves configuring L3 and L1 such that L3 is less than or equal to the combined length of L1 and the stroke of the tappet assembly 130. This ensures that during the retraction and pumping stroke of the tappet assembly 130, the groove 147 communicates with the area of the pumping plunger parts 142a/142b including the interface 143. As the interface 143 passes the groove 147, any pressure buildup present at the interface area 143 is released to low pressure to prevent holding of pressure between the plungers during the pumping stroke motion back to zero position (TDC). The length of the barrel bore 140 below the upper pumping plunger part 142b could be as short as practically possible for minimizing dilution of fuel from above into the oil, and the length L2 of the lower pumping plunger 142a can be as long as a pump design and engine space will allow.

Some conventional plunger assembly designs have attempted to reduce leakage and improve efficiency by using a one-piece plunger assembly having a particular profile. For example, one conventional fuel pump includes a single-piece plunger having a gradual taper along the length of the plunger. However, this tapered profile allows a significant amount of fuel leakage compared with the constant tight fit of the upper pumping plunger part 142b of the two-piece plunger assembly 142a/142b. Another conventional one-piece plunger assembly utilizes a profile having an upper pumping section and a lower driving section having different constant diameters. In this type of plunger, the diameter of the lower driving section is often significantly smaller relative to the diameter of the upper pumping section. However, the single-piece two-sectioned plunger is less efficient than the two-piece plunger assembly 142a/142b because the lower driving section typically does not substantially contribute to sealing a pump bore along a seal length of the bore. Additionally, the single-piece plunger more susceptible to sticking within the pump's barrel bore compared with fuel pump embodiments including a two piece plunger. By contrast, the fuel pump assembly embodiments described herein significantly reduce high pressure leakage while maintaining continuous operation.

During a pumping operation, the lower pumping plunger part 142a moves in a pumping stroke as the tappet assembly 130 and the force transmitting part 156 are displaced by the cam lobe 126 in a direction toward the head 112. The upper plunger part 142b can float in the barrel bore 140, but makes contact with or abuts the lower pumping plunger part 142a during the upstroke of the tappet assembly 130 and force transmitting part 156. The upper plunger part 142b compresses the fuel volume in the pumping chamber 144 to a prescribed pressure before being released to a common rail (not shown). For example, when the pressure in the pumping chamber 144 reaches a prescribed pressure level, an outlet check valve (not shown) connected to the pumping chamber 144 can open to provide the pressurized fuel to the common rail.

On the retraction stroke of the tappet assembly 130 and force transmitting part 156, which takes place just after cam lobe 126 has reached maximum lift, low pressure fuel from a fuel reservoir, for example fuel fed from a fuel tank by a low pressure pump (not shown), enters the pumping chamber 144 while the outlet to the high pressure rail is blocked. For example, a check valve of an outlet leading to the common rail (not shown) can remain closed when the pumping chamber 144 is at low pressure while another check valve opens to supply fuel from the low pressure pump. While fuel is entering the pumping chamber 144, the floating upper pumping plunger part 142b is forced downward toward the retreating lower pumping plunger part 142a because pressure in a region between an upper face of lower pumping plunger part 142a and an opposing lower face of upper pumping plunger part 142b is lower than pressure in the pumping chamber 144.

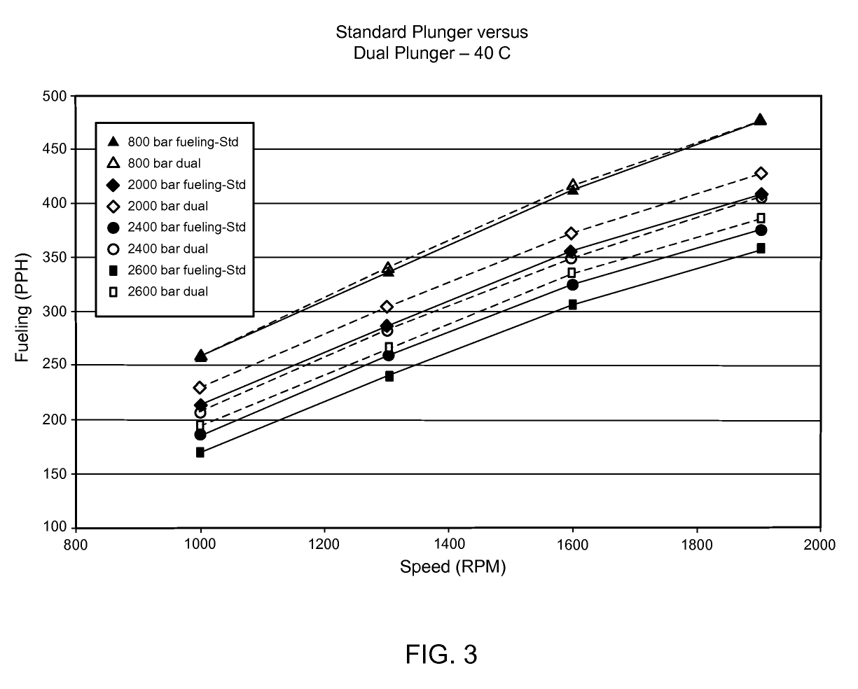

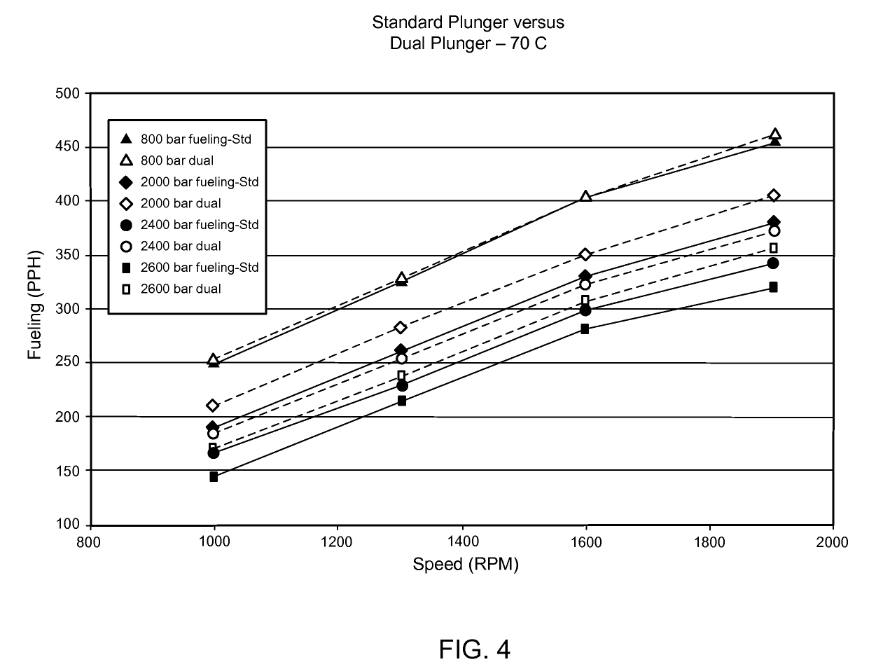

FIGS. 3 and 4 each include a graph showing fuel delivery rate versus engine RPM for a two-piece plunger pump and a standard single-piece plunger pump operating at various fueling pressures. These data are from a pump built with a single plunger in barrel (i.e., the standard arrangement), and then the single barrel was removed and dual plungers installed in the same barrels and rerun to show the efficiency improvement. So the pump barrels had been processed for both a single plunger and dual (two-piece) plungers so the only parts changed are the plungers for a clear back-to-back comparison.

The standard plunger pump had a 5.3 μm plunger-to-bore clearance for its single-piece plunger, and the two-piece plunger pump had a clearance of 5.3 μm for the lower plunger part and a clearance of 2.2 μm for the upper plunger part of the coaxial arrangement. The data of FIG. 3 was obtained by operating the two-piece plunger pump and standard single-piece plunger pump using fuel at a temperature of 40 C, and the data of FIG. 4 relates to the same pumps operated using fuel at a temperature of 70 C. As can be seen, the two-piece plunger pumps achieved significant improvements in the amount of fuel delivered at pressures over 800 bar compared with a standard single-piece plunger pump operating in the same conditions. For instance, FIG. 3 shows at least a 10% volumetric efficiency increase for a two-piece plunger pump over a standard single-piece plunger pump at engine speeds between 1000 and 1600 RPM. FIG. 4 shows similar results obtained with warmer fuel, but overall volumetric efficiency was shown to decrease at the higher 70 C temperature. FIGS. 3 and 4 also show that increases in volumetric efficiencies are less significant at 800 bar because leakage is less a factor at such lower pressures.

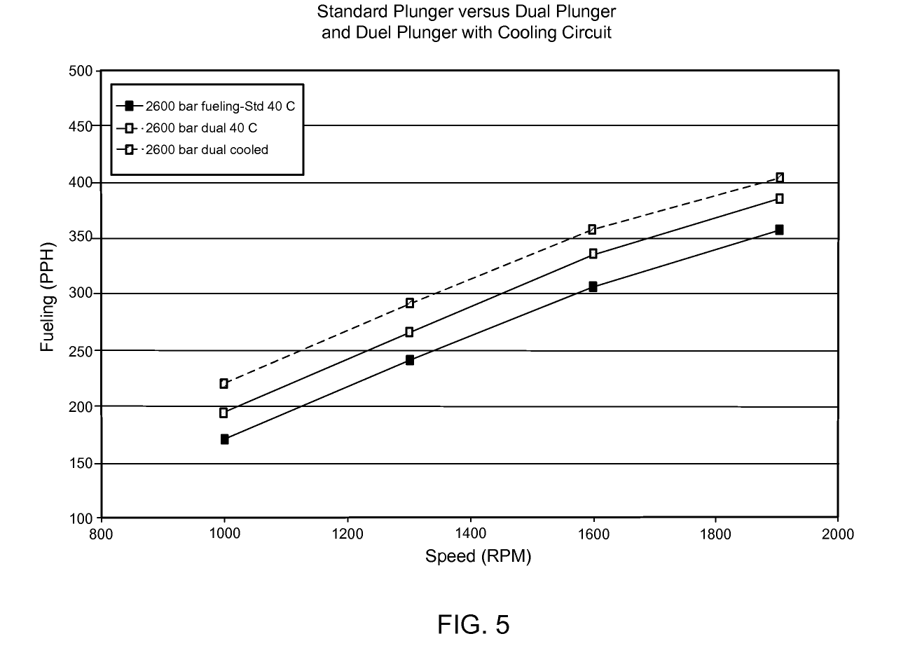

Greater volumetric efficiencies can be obtained by cooling the two-piece plunger pump, for example, by cooling the barrel of the pump using a cooling fluid or providing a fuel cooling unit upstream from the pump. FIG. 5 shows data of FIG. 3 related to fuel delivery rate versus engine RPM for a two-piece plunger pump and the standard single-piece plunger pump delivering fuel at 2600 bar along with data related to a cooled two-piece plunger pump operating under the same pressure and engine speeds. Fuel was passed through a fluid circuit in the pump barrel to cool the barrel and other pump elements by removing heat from those pumping elements. As can be seen from FIG. 5, using a cooling circuit to remove heat from the two-piece plunger pump increased volumetric efficiency by about 20% or more from those achievable for the standard single-piece plunger pump supplied with 40 C temperature fuel at the inlet. A novel manner of cooling a pumping barrel and other pump elements using a cooling fuel flow is disclosed in copending U.S. patent application Ser. No. 12/398,570, filed Mar. 5, 2009, which is hereby incorporated by reference in its entirety.

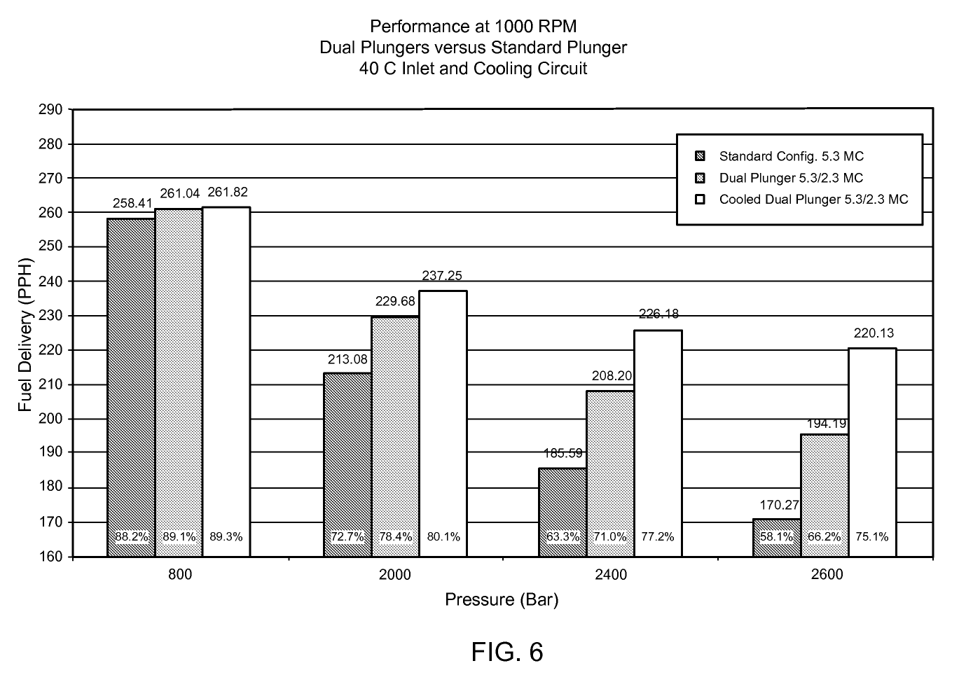

FIG. 6 is a graph depicting performance test results of exemplary two-piece plunger pump assemblies and a standard single-piece plunger pumping assembly for various pumping pressures at 1000 RPM. The clearances of the two-piece plunger parts and the barrel bore pump were 5.3 μm for the plunger part closest to the tappet assembly and 2.3 μm for the part closest to the pumping chamber. One two-piece plunger pumping assembly was operated using fuel at an inlet temperature of 40 C, and the pump was cooled for the other two-piece pumping assembly. The standard single-piece pump configuration used had a bore-to-plunger clearance of 5.3 μm and an inlet fuel temperature of 40 C. Volumetric efficiencies for a sweep volume of 293.1 PPH are depicted inside each of the bars for the respective pump. As can be seen from the results across pressures of 800, 2000, 2400 and 2600 bar, the two-piece plunger pumps outperformed the standard single-piece plunger pump configuration in fuel delivery in each instance, with the cooled two-piece pumping assembly achieving the best performance of the three tested configurations. Accordingly, a cooling unit or system can optionally be placed in the fuel supply upstream an inlet of the pump barrel, or the pump barrel and other pump elements can be cooled to provide greater volumetric efficiency.

It will be appreciated that the embodiments described and shown herein may be modified in a number of ways. For instance, while the exemplary embodiments described above include an in-line arrangement of plural pumping units, other embodiments consistent with the invention can include more or less two-piece plunger pumps and/or arrange two-piece plunger pumps in another way, such as a radial arrangement driven by a ring cam. Additionally, the two-piece plunger pumps may be driven by any shaft driven by an internal combustion engine, such as a drive shaft or camshaft, although other mechanisms commonly employed to drive ancillary equipment in an internal combustion engine can be used, such as a belt drive.

Although a limited number of embodiments is described herein, one of ordinary skill in the art will readily recognize that there could be variations to any of these embodiments and those variations would be within the scope of the appended claims. Thus, it will be apparent to those skilled in the art that various changes and modifications can be made to the high pressure two-piece plunger pump assembly described herein without departing from the scope of the appended claims and their equivalents.

What is claimed is:

1. A high pressure pump apparatus for of an internal combustion engine, comprising:
a pump barrel including a bore having a central axis;
a two-piece pumping plunger including a first pumping plunger part and a second pumping plunger part that is separate from the first pumping plunger part, said first and second pumping plunger parts arranged substantially coaxial with the bore central axis; and
a tappet assembly, wherein
a first distal end portion of the first pumping plunger part abuts a first distal end portion of the second pumping plunger part,
a second distal end portion of the first pumping plunger part defines in part a pumping chamber, and
the tappet assembly is operably coupled to the second distal end portion of the second pumping plunger part for operably engaging a rotating camshaft to cause the first and second plunger parts to move in reciprocal motion.

2. The apparatus of claim 1, wherein a first clearance distance between a side surface of the first pumping plunger part and a surface of the bore is smaller than a second clearance distance between a side surface of the second pumping plunger part and the bore surface.

3. The apparatus of claim 3, wherein the first clearance distance is between one fourth to one half the second clearance distance.

4. The apparatus of claim 4, further comprising a cooling circuit that cools the pump barrel.

5. The apparatus of claim 1, wherein the pump barrel bore comprises a groove to allow escape of leaking high pressure fuel to low pressure.

6. The apparatus of claim 5, wherein a longitudinal sealing length of said upper pumping plunger part extends along a majority of the length of the barrel bore between said groove and a distal end of the barrel bore.

7. The apparatus of claim 5, wherein a distance measured from the low pressure groove to the second distal end portion of the first pumping plunger part when the first pumping plunger part is at top dead center in the bore of barrel is less than or equal to a combined length of the first plunger part and the stroke of the reciprocally driven tappet assembly.

8. A high pressure fuel pump, comprising:
a pump barrel including a cylindrically shaped bore;
a pumping chamber at one end of the bore;
a first cylindrically shaped plunger part positioned in the bore and including a side surface defining a movable surface of the pumping chamber; and
a second cylindrically shaped plunger part positioned in the bore and having a diameter slightly smaller than a diameter of the first plunger part, said second cylindrically shaped plunger part being separate from the first cylindrically shaped plunger part and adapted to be reciprocally driven at a first end and to drive the first plunger part in the bore at a second end.

9. The pump of claim 8, wherein a difference in diameters between the bore and the first plunger part is between one fourth to one half the difference in diameters between the bore and the second plunger part.

10. The pump of claim 8, further comprising a cooling circuit that cools the pump barrel.

11. The pump of claim 8, wherein the cylindrically shaped bore of pump barrel comprises a groove to allow escape of leaking high pressure fuel to low pressure.

12. The pump of claim 11, wherein a longitudinal sealing length of said first cylindrically shaped plunger part extends along a majority of the length of the cylindrically shaped bore between said groove and a distal end of the cylindrically shaped bore.

13. The pump of claim 11, wherein a distance measured from the low pressure groove to the side surface of the first plunger part when the first plunger part is at top dead center in the bore of pump barrel is less than or equal to a combined length of the first plunger part and the stroke of the reciprocally driven first plunger part.
